(19) United States
(12) Patent Application Publication
(10) Pub. No.: US 2012/0218661 A1
(43) Pub. Date: Aug. 30, 2012

(54) SPINDLE MOTOR, AND DISK APPARATUS HAVING THE SAME

(75) Inventor: Kenichi Yoshida, Hamura-shi (JP)

(73) Assignee: KABUSHIKI KAISHA TOSHIBA, Tokyo (JP)

(21) Appl. No.: 13/402,556

(22) Filed: Feb. 22, 2012

(30) Foreign Application Priority Data
Feb. 28, 2011 (JP) 2011-042474

(51) Int. Cl. G11B 17/02; H02K 21/12

(52) U.S. Cl. 360/97.13; 310/85; G9B/17.002

(57) ABSTRACT

According to one embodiment, a spindle motor includes: a bearing portion fixed to a base and configured to have a cylindrical outer shape; a stator provided with a core serving as a magnetic pole, and fixed to the base outside the bearing portion; a hub provided with a magnet facing the core, and rotatably supported by the bearing portion; and a shielding structure including: a shielding plate configured to shield airflow between the stator and the hub; a first elastic member configured to attach the shielding plate closely to the bearing portion at a top end of a cylindrical outer shape of the bearing portion; and a second elastic member configured to attach the shielding plate closely to the base at the region spreading outwardly from an outer end of the hub.

### CROSS REFERENCE TO RELATED APPLICATION(S)

The application is based upon and claims the benefit of priority from Japanese Patent Application No. 2011-042474 filed on Feb. 28, 2011, the entire contents of which are incorporated herein by reference.

### BACKGROUND

1. Field

Embodiments of the present invention relate to a spindle motor for rotating a disk, and a disk apparatus having the same.

2. Description of the Related Art

In recent years, disk apparatuses, such as magnetic disk apparatuses and optical disk apparatuses, utilizing disks have been widely used as information recording apparatuses for recording information. For example, the magnetic disk apparatus has at least a casing, a magnetic disk provided in the casing, a spindle motor for supporting and rotating the magnetic disk, and a magnetic head for reading information from the magnetic disk. The casing provided by the magnetic disk apparatus is substantially sealed to prevent unwanted materials or gasses from entering the apparatus from the outside of the apparatus.

However, sometimes, a gas is outgassed from an organic material contained in a component of the spindle motor, so that the outgassed gas enters the magnetic disk apparatus and adversely affects an operation of the magnetic disk. Thus, techniques for more reducing a gas outgassed from a spindle motor have been proposed.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a perspective view illustrating the internal structure of a magnetic disk drive (HDD) serving as a disk apparatus according to an embodiment, from which a top cover is removed;

FIG. 2 is a cross-sectional view of a spindle motor according to the embodiment, which is taken on a line passing through the center of rotation of the spindle motor provided in the HDD;

FIG. 3 is a perspective view of a shielding plate according to the embodiment;

FIG. 4 is a cross-sectional view of another spindle motor according to another embodiment, which is taken on a line passing through the center of rotation of the spindle motor provided in the HDD; and

FIG. 5 is a perspective view of a shielding member according to the another embodiment.

### DETAILED DESCRIPTION

According to one embodiment, a spindle motor includes: a bearing portion fixed to a base and configured to have a cylindrical outer shape; a stator provided with a core serving as a magnetic pole, and fixed to the base outside the bearing portion; a hub provided with a magnet facing the core, and rotatably supported by the bearing portion; and a shielding structure including: a shielding plate configured to shield airflow between the stator and the hub; a first elastic member configured to attach the shielding plate closely to the bearing portion at a top end of a cylindrical outer shape of the bearing portion; and a second elastic member configured to attach the shielding plate closely to the base at the region spreading outwardly from an outer end of the hub.

Hereinafter, embodiments of the invention are described with reference to the accompanying-drawings.

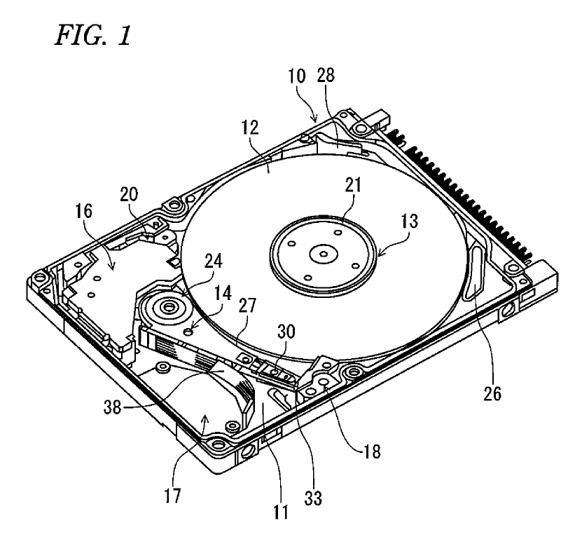

FIG. 1 is a perspective view illustrating the internal structure of a magnetic disk drive (hereinafter referred to also as a HDD) serving as a disk apparatus according to this embodiment, from which a top cover is removed.

The following description is given by defining a side to which an arrow extending in a Z-direction is directed, and the opposite side as an upper side and a lower side, respectively.

As illustrated in FIG. 1, the HDD is provided with a casing 10. The casing 10 includes a rectangular-box-like base 11 opened in the top side thereof, and a top cover (not shown) removed therefrom. The top cover is combined with the base 11 by a plurality of fastening members (e.g., screws) and closes an aperture opened in the top side of the base 11. Consequently, the inside of the casing 10 is maintained hermetically. A part at the side of the base 11 of the casing 10 can be ventilated with external air through a breather filter 26. On the other hand, a breather filter can be provided in the top cover. Thus, a part at the side of the top cover of the casing 10 can be ventilated with external air through this breather filter. The base 11 and the top cover are formed of, e.g., an aluminum material or an iron material.

The base 11 is provided with at least one magnetic disk 12 serving as a recording medium, a spindle motor 13 for supporting and rotating the magnetic disk 12, at least one magnetic head 33 for recording and reproducing information on and from the magnetic disk 12, a carriage 14 for supporting the magnetic head 33 movably with respect to a surface of the magnetic disk 12, and a voice coil motor 16 (hereinafter referred to also as a VCM) for turning and positioning the carriage 14.

The base 11 is provided with a ramp mechanism 18 for holding, when the magnetic head 33 moves to or outwardly from the outermost periphery of the magnetic disk 12, the magnetic disk 12 at a retracted position separated from the magnetic head 33, a latch mechanism 20 for holding, when an impact acts upon the HDD, the carriage 14 at a retracted position, and a board unit 17 on which electronic components such as a pre-amplifier, are mounted. The base 11 is further provided with a circulation filter 28 for eliminating grit and dust contained in the casing 10, and the breather filter 26 for capturing grit and dust from external air sucked into the casing 10 from the outside.

A printed circuit board (not shown) is fixed to the bottom side of the base 11 with fastening members (e.g., screws). That is, the printed circuit board is provided to face the bottom of the base 11. The printed circuit board is electrically connected to the VCM 16 and the magnetic head 33 via the board unit 17. The printed circuit board is electrically connected to the spindle motor 13 via motor electrodes (not shown). Electronic components for controlling the VCM 16 and the spindle motor 13, and transmitting and receiving signals to and from the magnetic head 33 are mounted on the printed circuit board.

The spindle motor 13 is rotated under the control of the electronic components mounted on the printed circuit board. The spindle motor 13 is configured to include a coil and a magnet. The spindle motor 13 is rotated by energizing the coil. The wire configured by the coil is drawn out of the casing 10 from a hole portion opened in a part of the bottom wall of the base 11 and electrically connected to the motor electrodes via flexible printed circuits (FPC) attached to the bottom of the base 11. With such a configuration, the coil provided by the spindle motor 13 is electrically connected to the electronic components mounted on the printed circuit board.

The magnetic disk 12 is formed to have a diameter of 65 mm (2.5 inches) and to include a magnetic recording layer on each of the top surface and the bottom surface thereof. The magnetic disk 12 is coaxially fit onto a hub of the spindle motor 13, which will be described below. In addition, the magnetic disk 12 is fixed to the hub with a clamper 21 screwed onto the top of the hub. The magnetic disk 12 is rotated by the spindle motor 13 serving as a drive motor at a predetermined rotation speed (corresponding to, e.g., 5400 revolutions per minute (rpm) or 7200 rpm).

A carriage 14 includes a bearing assembly 24 that is fixed to the bottomwall of the base 11 and functions as a bearing portion. The bearing assembly 24 includes a pivot shaft erected on the bottom wall of the base 11, and a cylindrical hub rotatably supported by the pivot shaft via a pair of bearings. The carriage 14 includes at least one arm 27 attached to the bearing assembly 24, a suspension 30 extended from the arm 27, and the magnetic head 33 supported at an end portion of the extended suspension 30.

The magnetic head 33 includes a substantially rectangular slider (not shown), and a recording element and a reproducing head element (not shown) formed on this slider. The magnetic head 33 is fixed to a gimbal portion formed at the end portion of the suspension 30. The magnetic head 33 is electrically connected to a board unit 17 via a relay flexible printed circuit board (hereinafter, the flexible printed circuit board is referred to also as the FPC) attached to the carriage 14, and via a main FPC 38.

According to the present embodiment, with such a configuration, the spindle motor 13 rotates the magnetic disk 12 at the predetermined rotation speed. The VCM 16 rotates the carriage 14 around the bearing assembly 24 and moves the magnetic head 33 provided on the carriage 14 to a position corresponding to a recording surface of the magnetic disk 12. The magnetic head 33 floats up over the recording surface of the magnetic disk in a state in which the magnetic disk 12 rotates, and records and reproduces information on and from the magnetic disk 12.

A plurality of magnetic disks 12 and a plurality of heads 33 can be provided in the HDD. In this case, the magnetic heads 33 correspond to the magnetic recording layers of the magnetic disks 12, respectively.

Next, the structure of the spindle motor 13 according to the present embodiment is described in detail hereinafter.

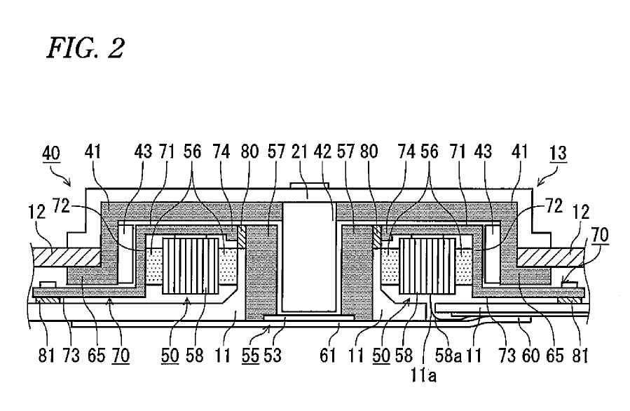

FIG. 2 is a cross-sectional view of the spindle motor 13 provided in the HDD according to the present embodiment, which is taken on a line passing through the center of rotation of the spindle motor 13.

As illustrated in FIG. 2, the spindle motor 13 includes a rotor 40 serving as a body of rotation, and a stator 50 serving as a fixed body. The spindle motor 13 includes a hub 41 configured as the rotor 40, and a shaft 42 fixed to the hub 41. The hub 41 is formed to have a cylindrical shape whose top is substantially blocked up, and a hole portion provided at a substantially center of the top wall configured by the substantially blocked-top end portion. The shaft 42 is shaped like a cylinder whose outer surface has a diameter substantially equal to that of the hole portion provided at the substantially center of the top wall of the hub 41 and is fit into the hole portion so as to be fixed to the hub 41. The shaft 42 is rotatably supported with respect to the base 11 by a fluid dynamic bearing 55.

The fluid dynamic bearing 55 includes a sleeve 57 which is fixed to the base 11 and has cylindrical inner and outer surfaces, and a thrust plate 53 which blocks up a bottom opening of the sleeve 57. The sleeve 57 is fit into the cylindrical hole portion formed by the base 11 which upwardly extends. The sleeve 57 is formed to have a height shorter than the height of the upwardly extending base 11 by a predetermined length. The shaft 42 is inserted into the sleeve 57 so that a slight gap is provided between the outer surface of the shaft 42 and the inner surface of the sleeve 57. Fluids (e.g., lubricants) are filled into the gap between the outer surface of the shaft 42 and the inner surface of the sleeve 57 and that between the bottom surface of the shaft 42 and the thrust plate 53. A dynamic pressure generating groove (e.g., a herringbone-shaped groove) for generating a radial dynamic pressure by the rotation of the shaft 42 is formed on the outer surface of the shaft 42. Another dynamic pressure generating groove for generating a thrust direction dynamic pressure is formed on the bottom surface of the shaft 42.

A cylindrical magnet 43 is fixed to the inner surface of a cylindrical portion of the hub 41 and positioned coaxially with the shaft 42. The magnet 43 is exposed on the inner surface of the cylindrical portion of the hub 41 and extends axially from the top portion to the bottom portion of the hub 41. The magnet 43 has a plurality of N-poles and a plurality of S-poles formed alternately at uniform intervals along a circumferential direction. An annular flange 65 is formed integrally with the bottom of the cylindrical portion of the hub 41. The magnetic disk 12 is coaxially fit onto the bottom of the hub 41 and abuts on the flange 65. The magnetic disk 12 is provided between the clamper 21 and the flange 65.

The clamper 21 is fixed to the substantially center of the top of the shaft 42 with screws and fits the magnetic disk 12 onto the bottom of the hub 41.

The stator 50 is formed substantially annularly. The stator 50 is fixed to the base 11 which upwardly extends, outside the sleeve 57. The stator 50 is placed coaxially with the shaft 42 along a circumferential direction. The stator 50 includes cores 56 each of which is formed by stacking a plurality of metal plates and a plurality of coils 58 wound around each of the cores 56. The cores 56 and the coils 59 configure a plurality of magnetic poles. The magnetic poles are provided at uniform intervals along a circumferential direction. Each of the magnetic poles is placed to face an associated one of the magnetic poles of the magnet 43.

A hole portion 11a is provided in a part of the bottom wall of the base 11. One end 58a of the wire configuring each of the coils 58 is passed through the hole portion 11a and drawn out of the casing 10 (more specifically, the bottom of the base 11) in order to energize the coil 58. The one end 58a of the wire drawn out of the casing 10 is electrically connected to an electrode provided at one end of the FPC 60 attached to the bottom of the base 11 by an electrically conductive member (e.g., solder). The hole portion 11a is sealed by being filled with a non-conductive fixing material. The fixing material is, e.g., an adhesive-agent. The thrust plate 53, the hole portion 11a, and one end of the FPC 60, to which the one end 58a of the wire is connected, are covered with a label 61 configured to have a bonding surface at the side of the base 11 thereof. A region, on which the spindle motor 13 is provided, on the bottom side of the base 11 is hermetically closed by the label 61.

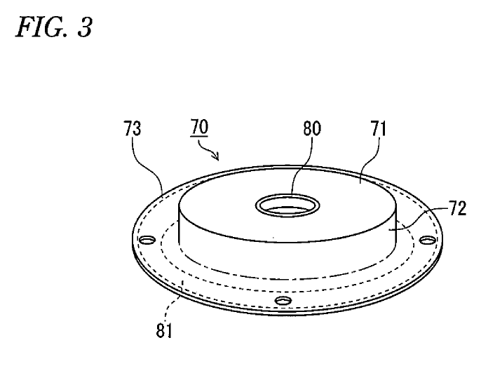

The spindle motor 13 according to the present embodiment includes a shielding plate 70 provided between the rotor 40 and the stator 50. FIG. 3 is a perspective view illustrating the shielding plate 70. The shielding plate 70 includes a top surface portion 71 having a central hole of a diameter larger than that of the cylindrical outer surface of the sleeve 57 at a substantially center thereof, a cylindrical portion 72 extending substantially straight and downwardly from the outer circumferential edge of the top surface portion 71, and a bottom surface portion 73 spreading outwardly and substantially straight from the bottom end of the cylindrical portion 72. The shielding plate 70 includes an inner cylindrical portion 74 extending substantially straight and downwardly from the inner circumferential edge of the top surface portion 71. The inner cylindrical portion 74 can be formed by drawing.

The top surface portion 71 is bonded by the fixing material to the upper side of at least one of the plurality of coils 58 respectively wound around the cores 56 to inhibit the upper side thereof from touching the top wall of the hub 41. The inner side of the cylindrical portion 72 abuts against the cores 56. The cylindrical portion 72 can be bonded to the cores 56 by the fixing material. The cylindrical portion 72 is placed along a circumferential direction so as not to touch the magnet 43 outside the cores 56. The bottom surface portion 73 extends outwardly from the outer end of the flange 65 along the upper side of the base 11 so as not to touch the flange 65. The bottom surface portion 73 is fixed to the base 11 at a region which is included in the bottom surface portion 73 and extends outwardly from the outer end of the flange 65. That is, the shielding plate 70 is fixed to the stator 50 and the base 11 so as not to touch the rotor 40. The shielding plate 70 is formed of, e.g., a non-magnetic material, such as aluminum. Because the shielding plate 70 is formed of the non-magnetic material, the shielding plate 70 doesn't magnetically shield between the magnetic pole of the stator 50 and that of the magnet 43. It is advisable to form the shielding plate 70 so as to have a thickness of about 0.1 mm.

A buffer member 80 formed like a cylinder to have elasticity is provided between the inner cylindrical portion 74 and the sleeve 57. The buffer member 80 is provided on an upper part of the top portion of the upwardly extending base 11 coaxially with the top end of the outer cylindrical surface of the sleeve 57. Because the buffer member 80 has elasticity, the shielding plate 70 is closely attached to and fit into the sleeve 57. A buffer member 81 formed annularly to have elasticity is provided between the bottom surface portion 73 and the base 11. The bottom surface portion 73 is fixed to the base 11 via the buffer member 81 by fastening members (e.g., screws). Because the buffer member 81 has elasticity, the shielding plate 70 is closely attached and fixed to the base 11. The buffer members 80 and 81 are formed of a low-gas-permeability material, e.g., a fluorine-based material. Airflow to be caused to flow between the rotor 40 and the stator 50 is shielded by providing the buffer member 80 between the shielding plate 70 (more specifically, the inner cylindrical portion 74) and the sleeve 57 and the buffer member 81 between the shielding plate 70 (more specifically, the bottom surface portion 73) and the base 11. That is, the shielding plate 70 and the buffer members 80 and 81 configure a shielding structure. Thus, the hermeticity of a space at the side of the rotor 40 of the spindle motor 13 is assured.

Although a mode of sealing the hole portion 11a in a part of the bottom wall of the base 11 with the fixing material has been described, the hole portion 11a is not necessarily sealed with the fixing material. According to the present embodiment, even when there is no fixing material to be filled into the hole portion 11a, the hermeticity of the inside of the casing 10 is assured by the shielding structure. That is, according to the present embodiment, the fixing material filled into the hole portion 11a can be omitted.

Thus, the fixing materials are used at many places in order to fix a plurality of components configuring the stator 50 provided in the spindle motor 13. Generally, the fixing material is an organic adhesive-agent form which gas is outgassed. It is known that when gas outgassed therefrom enters the casing 10, the gas adversely affects operations of the HDD. The spindle motor 13 according to the present embodiment is provided with the shielding structure configured by the shielding plate 70 and the buffer members 80 and 81. Accordingly, in accordance with the spindle motor 13 according to the present embodiment, gas outgassed from the spindle motor can be more restricted from entering the apparatus.

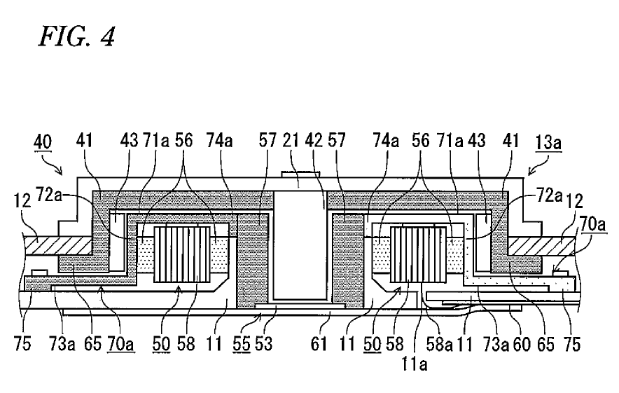

Next, the structure of a spindle motor 13a which is a modification of the spindle motor 13 according to the present embodiment is described hereinafter in detail with reference to FIG. 4.

FIG. 4 is a cross-sectional view illustrating another spindle motor 13a according to the modification of the present embodiment, which is taken on a line passing through the center of rotation of the spindle motor 13a provided in the HDD.

Among most of components illustrated in FIG. 4, the same components as those illustrated in FIG. 2 are designated with the same reference numeral used to denote those in FIG. 2. Thus, the detailed description of such components is omitted. The shielding structure illustrated with reference to FIG. 2 includes the shielding plate 70, and the buffer members 80 and 81, which are formed as components that are independent of one another. A shielding structure described with reference to FIG. 4 is formed as a shielding member 70a which is a single component configured by forming the shielding plate and the buffer members integrally with one another.

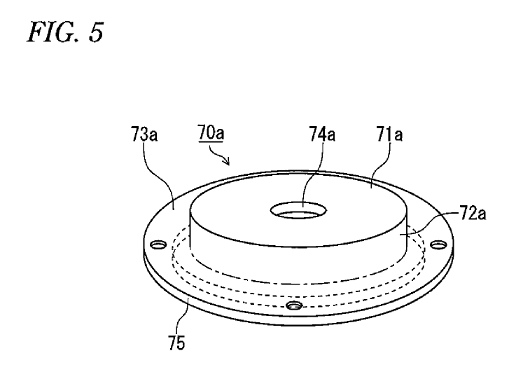

The spindle motor 13a according to the modification of the present embodiment includes the shielding plate 70a provided between the rotor 40 and the stator 50. FIG. 5 is a perspective view illustrating the shielding member 70a. The shielding plate 70a includes a top surface portion 71a having a central hole of a diameter larger than that of the cylindrical outer surface of the sleeve 57 at a substantially center thereof, a cylindrical portion 72a extending substantially straight and downwardly from the outer circumferential edge of the top surface portion 71a, and a bottom surface portion 73a spreading outwardly and substantially straight from the bottom end of the cylindrical portion 72a. The shielding plate 70a includes an inner cylindrical portion 74a extending substantially straight and downwardly from the inner circumferential edge of the top surface portion 71a, and an outer cylindrical portion 75 extending downwardly from the outer circumferential edge of the bottom surface portion 73a.

The top surface portion 71a is bonded by the fixing material to the upper side of at least one of the plurality of coils 58 wound around the cores 56 to inhibit the upper side thereof from touching the top wall of the hub 41. The inner side of the cylindrical portion 72a abuts against the cores 56. The cylindrical portion 72a can be bonded to the cores 56 by the fixing material. The cylindrical portion 72a is placed along a circumferential direction so as not to touch the magnet 43 outside the cores 56. The bottom surface portion 73a extends outwardly from the outer end of the flange 65 along the upper side of the base 11 so as not to touch the flange 65. The inner cylindrical portion 74a is provided on an upper part of the top portion of the upwardly extending base 11 coaxially with the top end of the outer cylindrical surface of the sleeve 57. The inner side of the inner cylindrical portion 74a abuts against the outer cylindrical surface of the sleeve 57. The outer cylindrical portion 75 is fixed to the base 11 with the fastening members (e.g., screws) at a region which is included in the outer cylindrical portion 75 and extends outwardly from the outer end of the flange 65. The bottom side of the outer cylindrical portion 75 abuts on the top side of the base 11. That is, the shielding member 70a is fixed to the stator 50 and the base 11 so as not to touch the rotor 40.

The shielding member 70a is formed of, e.g., a non-magnetic material having elasticity. The shielding member 70a is formed of a low-gas-permeability material, e.g., a fluorine-based material. Because the shielding member 70a has elasticity, the shielding member 70a is closely attached to and provided on the sleeve 57 and the base 11. In addition, because the shielding member 70a is formed of the non-magnetic material, the shielding member 70a doesn't magnetically shield between the magnetic pole of the stator 50 and that of the magnet 43. It is advisable to form the shielding member 70a so as to have a thickness of about 0.1 mm. Airflow to be caused to flow between the rotor 40 and the stator 50 is shielded by providing the shielding member 70a. That is, in the spindle motor 13a, the shielding member 70a integrally configures a shielding structure. Thus, the hermeticity of a space at the side of the rotor 40 of the spindle motor 13 is assured.

In the spindle motor 13a, the fixing materials are used at many places in order to fix a plurality of components configuring the stator 50. The fixing material used in the spindle motor 13a is, e.g., an organic adhesive-agent from which gas is outgassed. The spindle motor 13a according to the modification of the present embodiment is provided with the shielding structure integrally configured by the shielding member 70a. Accordingly, according to the modification of the present embodiment, gas outgassed from the spindle motor 13a can be more restricted from entering the apparatus.

As described above, the modification of the present embodiment provides a spindle motor in which a shielding structure integrally configured by a plurality of components or a single component is provided between the rotor and the stator. The shielding structure abuts against a component via another component. A component formed of a non-magnetic material is provided between the magnetic pole of the stator and that of the rotor. The shielding structure doesn't magnetically shield between the rotor-side space and the stator-side space. However, the shielding structure shields airflow therebetween. That is, although gas is outgassed from the state-side space, the shielding structure assures the hermeticity of the rotor-side space. That is, according to the modification of the present embodiment, gas outgassed from the spindle motor can be more restricted from entering the disk apparatus.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A spindle motor comprising:
a bearing portion fixed to a base, and comprising a cylindrical outer shape;
a stator comprising a core configured as a magnetic pole, the stator fixed to the base outside the bearing portion;
a hub comprising a magnet facing the core, the hub rotatably supported by the bearing portion; and
a shielding structure comprising:
a shielding plate configured to shield airflow between the stator and the hub;
a first elastic member configured to attach the shielding plate to the bearing portion at a top end of the cylindrical outer shape of the bearing portion; and
a second elastic member configured to attach the shielding plate to the base at a region spreading outward from an outer end of the hub.

2. The spindle motor according to claim 1, wherein the shielding plate comprises a non-magnetic material.

3. The spindle motor according to claim 2, wherein:
the stator comprises a coil wound around the core; and
the shielding plate is fixed to the coil with a fixing material.

4. The spindle motor according to claim 3, wherein:
the shielding plate comprises:
a top surface portion comprising a central hole having a diameter larger than that of the cylindrical outer surface of the bearing portion at a center thereof;
a cylindrical portion extending substantially straight downward from an outer circumferential edge of the top surface portion;
a bottom surface portion spreading outward and substantially straight from a bottom of the cylindrical portion; and
an inner cylindrical portion extending substantially straight downward from an inner circumferential edge of the top surface portion,
wherein the first elastic member comprises a cylindrical shape between the inner cylindrical portion and the bearing portion, and
wherein the second elastic member comprises an annular elastic member between the bottom surface portion and the base.

5. The spindle motor according to claim 1, wherein the shielding plate, the first elastic member, and the second elastic member form a single component.

6. The spindle motor according to claim 2, wherein the shielding plate, the first elastic member, and the second elastic member form a single component.

7. The spindle motor according to claim 3, wherein the shielding plate, the first elastic member, and the second elastic member form a single component.

8. The spindle motor according to claim 4, wherein the shielding plate, the first elastic member, and the second elastic member form a single component.

9. A disk apparatus comprising:
a casing comprising a base;
a recording medium in the casing; and
a spindle motor configured to rotate the recording medium,
wherein the spindle motor comprises:
a bearing portion fixed to a base, and comprising a cylindrical outer shape;
a stator comprising a core configured as a magnetic pole, the stator fixed to the base outside the bearing portion;
a hub comprising a magnet facing the core, the hub rotatably supported by the bearing portion; and
a shielding structure comprising:
a shielding plate configured to shield airflow between the stator and the hub;
a first elastic member configured to attach the shielding plate to the bearing portion at a top end of the cylindrical outer shape of the bearing portion; and
a second elastic member configured to attach the shielding plate to the base at a region spreading outward from an outer end of the hub.

10. The disk apparatus according to claim 9, wherein the shielding plate comprises a non-magnetic material.

11. The disk apparatus according to claim 10, wherein:
the stator comprises a coil wound around the core; and
the shielding plate is fixed to the coil with a fixing material.

12. The disk apparatus according to claim 11, wherein:
the shielding plate comprises:
a top surface portion comprising a central hole having a diameter larger than that of the cylindrical outer surface of the bearing portion at a center thereof;
a cylindrical portion extending substantially straight downward from an outer circumferential edge of the top surface portion;
a bottom surface portion spreading outward and substantially straight from a bottom of the cylindrical portion; and
an inner cylindrical portion extending substantially straight downward from an inner circumferential edge of the top surface portion;
wherein the first elastic member comprises a cylindrical shape between the inner cylindrical portion and the bearing portion; and
wherein the second elastic member comprises an annular elastic member between the bottom surface portion and the base.

13. The disk apparatus according to claim 9, wherein the shielding plate, the first elastic member, and the second elastic member form a single component.

14. The disk apparatus according to claim 10, wherein the shielding plate, the first elastic member, and the second elastic member form a single component.

15. The disk apparatus according to claim 11, wherein the shielding plate, the first elastic member, and the second elastic member form a single component.

16. The disk apparatus according to claim 12, wherein the shielding plate, the first elastic member, and the second elastic member form a single component.
